(19) United States
(12) Patent Application Publication
(10) Pub. No.: US 2008/0301448 A1
(43) Pub. Date: Dec. 4, 2008

(54) Security Against Corruption for Networked Storage

(75) Inventors: Denis X. Charles, Redmond, WA (US); Kamal Jain, Bellevue, WA (US); Kristin E. Lauter, La Jolla, CA (US); Jin Li, Sammamish, WA (US); Dan Teodosiu, Dublin (IE)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/757,282

(22) Filed: Jun. 1, 2007

(51) Int. Cl. H04L 9/00

(52) U.S. Cl. 713/176

(57) ABSTRACT

Systems and methods for security against corruption for networked storage are described. In one aspect, a destination device receives a linear combination of packets. The linear combination of packets represents digitally signed blocks of content and public information used to digitally sign segmented blocks of content. The destination device recombines the linear combination of packets to compute new valid signatures as linear combinations of received homomorphic digital signatures. The new valid signatures are for verifying by a requesting computing device recovering data associated with at least a subset of the linear combination of packets, integrity of the at least a subset. This provides the requesting node with security against corruption of data in networked storage.

### BACKGROUND

Data can be securely stored by distributing it across a network of machines which are interconnected. One efficient way to do this is to use network coding of the data and distribute linear combinations of packets to each neighbor of a node, and so forth, so that the data from each machine is propagated throughout the network, and can be recovered from any of a number of other machines. Thus linear combinations of the data for one user would be stored on many machines, and the problem is to ensure that none of the data is corrupted or polluted when returned to the original user. A malicious user may inject garbage into a network intentionally to corrupt some packets of data; alternatively, a software error or hardware malfunction may corrupt some packets of data. In addition, recombining packets in network coding at a subsequent node may distribute the corrupted data throughout the network causing more content to be polluted.

### SUMMARY

Systems and methods for security against corruption for networked storage are described. In one aspect, a destination device receives a linear combination of packets. The linear combination of packets represents digitally signed blocks of content and public information used to digitally sign segmented blocks of content. The destination device recombines the linear combination of packets to compute new valid signatures as linear combinations of received homomorphic digital signatures. The new valid signatures are for verifying by a requesting computing device recovering data associated with at least a subset of the linear combination of packets, integrity of the at least a subset. This provides the requesting node with security against corruption of data in networked storage.

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

### BRIEF DESCRIPTION OF THE DRAWINGS

In the Figures, the left-most digit of a component reference number identifies the particular Figure in which the component first appears.

FIG. 1 illustrates an exemplary system for security against corruption in networked storage, according to one embodiment.

FIG. 2 shows an exemplary procedure for security against corruption for networked storage, according to one embodiment.

FIG. 3 shows further aspects of the exemplary procedure of FIG. 2 for security against corruption for networked storage, according to one embodiment.

FIG. 4 shows an exemplary procedure for a requesting node to determine whether data received from one or more other nodes in the network has been corrupted or otherwise polluted since been originally stored on the other nodes, according to one embodiment.

### DETAILED DESCRIPTION

### Overview

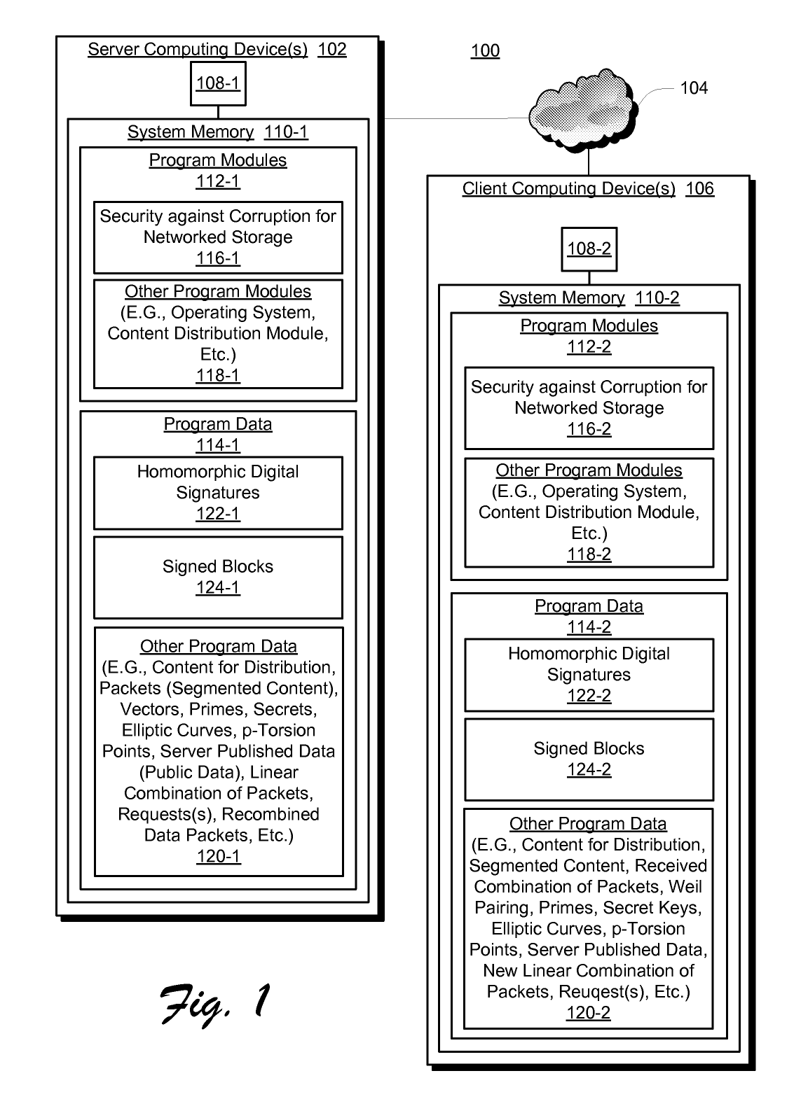

Systems (e.g., systems, apparatus, computer-readable media, etc.) and methods for security against corruption for networked storage are described below in reference to FIGS. 1-4. These systems and methods ensure that none of the data stored across a network of machines which are interconnected is corrupted or polluted when returned to an original user. The systems and methods guarantee integrity of the data recovered from any other node in a network. This is accomplished by adding digital signatures with a homomorphic property to each packet at the distribution source. These signatures are recombined as the packets are recombined to form valid signatures on new combinations of the data. The systems and methods then verify the signatures on incoming packets to ensure that the data has not been polluted. These and other aspects of the systems and methods for digital signatures in network coding are now described in greater detail.

### An Exemplary System

Although not required, the systems and methods for security against corruption for networked storage are described in the general context of computer-executable instructions (program modules) being executed by a computing device such as a personal computer. Program modules generally include routines, programs, objects, components, data structures, etc., that perform particular tasks or implement particular abstract data types. While the systems and methods are described in the foregoing context, acts and operations described hereinafter may also be implemented in hardware.

FIG. 1 shows an exemplary system 100 for digital signatures in network coding, according to one embodiment. In this implementation, system 100 represents a content distribution system. System 100 includes one or more server computing devices 102 coupled across a network 104 to any number of client computing devices 106. Each server 102 and client computing device 106 includes one or more respective processors 108 (e.g., 108-1 and 108-2) coupled to a respective system memory 110 (e.g., 110-1 and 110-2). A system memory 110 (i.e., tangible computer-readable media) includes computer-program modules 112 (e.g., 112-1 and 112-2) and program data 114 (e.g., 114-1 and 114-2). A processor 108 fetches and executes computer-program instructions from respective ones of the program modules 112. Program modules 112 include security against corruption for networked storage module 116 (e.g., 116-1 and 116-2) and other program modules 118 (e.g., 118-1 and 118-2) such as an operating system to provide a runtime environment, a content distribution model for network coding, etc. Security against corruption for networked storage module (“coding module”) 116 includes program logic to guarantee integrity of data recovered from any node 102 and/or 106 in network 104. For purposes of exemplary illustration, content for distribution, packets, crimes, received combinations of packets, etc. are shown as respective portions of “other program data” 120 (e.g., 120-1 and 120-2).

In this example, coding module 116-1 of server 102 initially segments content for distribution into smaller blocks of data. These block segments are shown as respective portions of segmented content (or packets) in “other data” 120-1. Coding module 116-1 converts the packets to vectors in a finite dimensional vector space over a large prime field of cryptographic size. More particularly, coding module 116-1 computes a respective homomorphic digital signature 122-1 for each of block segment using a digital signature scheme, and signs the block segment with the respective signature 122-1 to create a respective signed block 124-1. In system 100, a homomorphism is shown when a result obtained by adding two vectors in a vector space and hashing to an elliptic curve is the same as the sum of the respective hashes of the two vectors on that elliptic curve. An exemplary such scheme to sign the block segments is described below in the section titled “Exemplary Homomorphic Signature Scheme.” Server 102 communicates the signed blocks 124-1 as a linear combination of packets (or vectors) across network 104 to one or more neighboring nodes (i.e., client devices 106). Exemplary network coding operations to generate such a linear combination of packets are described in greater detail below in the section titled “Network Coding Model.”

Responsive to receiving the random linear combinations of packets comprising the signed blocks 124-1, a node 106 verifies the signature of the server 102 for each signed block 118. An exemplary such verification process based on bilinearity of the Weil-pairing is described below in the section titled “Exemplary Homomorphic Signature Scheme.” These verification operations allow the client device 106 to identify a dishonest server 102 within content distribution system 100. Responsive to verifying and authenticating each signed block 124-1, and if the node 106 is designated by the packets as the final destination for the received random linear combination of packets, the node recombines the received blocks/packets and computes new valid holographic digital signatures 122-2 as linear combinations of the received signatures.

If client device 106 is not designated by the linear combination of packets as being the final recipient for the received content, and if the received content has been successfully verified and authenticated, coding module 116-2, which knows the digital signatures of some of the received content: (a) re-signs the received content; and (b) redistributes the newly re-signed content as a new linear combination of packets (a respective portion of “other data” 116-2) to a different client device 106. This process is iterative until a respective client device 106 is a final destination for content in a linear combination of packets received from either a server 102 and/or a client device 106. These latter operations allow a data receiving client device 106 to sign packets combined at various nodes in the network 104 without contacting the source (e.g., server 102 and/or another client device 106) to sign the packets in the new linear combination of packets.

To recover a received combination of packets from a set of nodes 106 and ensure integrity, a node 106 uploads the combination of packets from corresponding nodes 106 and checks the corresponding homomorphic digital signatures 122-2 on the received packets. Any node 106 receiving data with an invalid signature 122-2 discards the received data instead of recombining it with other received packets. The received data is different packets from different users (neighbors or peers). Each received packet is a linear combination of other packets (recombined at the previous peer). In this manner, system 100 guarantees integrity of data recovered from any other node 106 or 102 in network 104.

### Elliptic Curve Background

This section presents aspects of elliptic curves over finite fields. An elliptic curve E over a finite field F_{q} (this is sometimes abbreviated as E/F_{q}). Referring to the finite field, q>3 is a power of a prime, and a projective curve in P²(F_{q}) is given by an equation of the form

Y²Z=X³+AXZ+BZ³,

with A,BεF_{q} and 4A³+27B²≠0. The curve has two affine pieces: the piece with Z≠0 has the affine form y²=x³+Ax+B (obtained by setting x=X/Z and y=Y/Z); and the piece with Z=0 which has only one (projective) point namely (0:1:0) which we denote O. Let K be a field (not necessarily finite) that contains F_{q}, the set

E(K)={(x,y)εK×K:y²=x³+Ax+B}∪{O}

can be given the structure of an abelian group with O as the identity of the group. Moreover, the group operations can be efficiently computed in particular, if P,Q are points on E with coordinates in F_{q}, then P+Q and −P can be computed in O(log^{1+ε} q) bit operations for any ε>0. Hasse's theorem gives a tight estimate for the size of the group E(F_{q}):

q+1−2\sqrt{q}≦#E(F_{q})≦q+1+2\sqrt{q}.

The Schoof-Elkies-Atkin algorithm is a deterministic polynomial time algorithm that computes #E(F_{q}).

### The Weil Pairing

Let E/F_{q} be an elliptic curve and let F̅_{q} be an algebraic closure of F_{q}. If m is an integer such relatively prime to the characteristic of the field F_{q}, then the group of m-torsion points, E[m]={PεE( F̅_{q}):mP=O}, have the following structure:

E[m]=Z/mZ×Z/mZ.

There is a map eₘ:E[m]×E[m]→ F̅*_{q} with the following properties:
The map eₘ is bilinear:

eₘ(S₁+S₂,T)=e(S₁,T)e(S₂,T)

eₘ(S,T₁+T₂)=e(S,T₁)e(S,T₂).
Alternating: eₘ(T,T)=1 and so eₘ(T,S)=eₘ(S,T)⁻¹.
Non-degenerate: If eₘ(S,T)=1 for all SεE[M] then T=O.

Let E/F_{q} be an elliptic curve and let S, T be two m-torsion points on E with coordinates in F_{q}. Then there is a deterministic algorithm that can evaluate eₘ(S,T) in O(log m log^{1+ε} q) bit operations. When clear from the context, the subscript m is dropped when writing eₘ.

### A Network Coding Model

A standard network coding framework for content distribution follows. Let G=(V,E) be a directed graph. A source sεV (e.g., a server 102 and/or a client 106) wishes to transmit some data (content for distribution) to a set T⊂V of the vertices. One chooses a vector space W/F (say of dimension d) and views the data to be transmitted (e.g., segmented content) as a bunch of vectors w₁, . . . , wₖεW. The source then creates the augmented vectors v₁, . . . , vₖ by setting

$${v}_{i} = ( \underbrace{0 , … , 0}_{i - 1 zeros} , 1 , … , 0 , {w}_{i 1} , … , {w}_{id} )$$

where wᵢⱼ is the j-th coordinate of the vector wᵢ. One can assume without loss of generality that the vectors vᵢ are linearly independent. We denote the subspace (of Fₚ^{k+d}) spanned by these vectors by V. Each edge eεE computes a linear combination, y(e), of the vectors entering the vertex v=in(e), that is to say

$$y ( e ) = {\sum }_{F \text{:} out ( f ) = v}^{ } {m}_{e} ( f ) y ( f )$$

where mₑεFₚ. We consider the source as having k input edges carrying the k vectors wᵢ. By induction one has that the vector y(e) on any edge is a linear combination y(e)=Σ_{1≦i≦k}gᵢ(e)vᵢ and is a vector in V. The k-dimensional vector g(e)= [symbol] g₁(e), . . . , gₖ(e) [symbol] is simply the first k-coordinates of the vector y(e). We call the matrix whose rows are the vectors g(e₁), . . . , g(eₖ), where eᵢ are the incoming edges for a tεT, as the global encoding matrix for t and denote it Gₜ. In practice the encoding vectors are chosen at random so the matrix Gₜ is invertible with high probability. Thus any receiver, on receiving y₁, . . . , yₖ can find w₁, . . . , wₖ by solving

$$[ \begin{matrix}{y}_{1} \\ {y}_{2} \\ ⋮ \\ {y}_{{k}^{′}}\end{matrix} ] = {G}_{t} [ \begin{matrix}{w}_{1} \\ {w}_{2} \\ ⋮ \\ {w}_{{k}^{′}}\end{matrix} ] ,$$

where the yᵢ are the vectors formed by removing the first k coordinates of the vector yᵢ.

### An Exemplary Homomorphic Signature Scheme

Network coding module 116 (i.e., coding modules 116-1, 116-2, through 116-N; there can be any number N of nodes 106) implements the following exemplary homomorphic signature scheme. Let p be a prime number (shown as respective portions of “other program data” 120) and q a power of a different prime with p<<q. Let V/Fₚ be a vector space of dimension d+k and let E/F_{q} be an elliptic curve such that R₁, . . . , Rₖ, P₁, . . . , P_{d} are all (distinct) points of p−torsion on E(F_{q}). We can define a function h_{R}_{₁}_{, . . . , P}_{ₖ}_{, P}_{₁}_{, . . . , P}_{_{d}}:V→E(F_{q}) as follows: for v= [symbol] u₁, . . . , uₖ, v₁, . . . v_{d} [symbol] εV

$${h}_{{R}_{1} , … , {R}_{k} , {P}_{1} , … , {P}_{d}} ( v ) = {\sum }_{j}^{ } {u}_{j} {R}_{j} + {\sum }_{i}^{ } {v}_{i} {P}_{i} .$$

The function h_{R}_{₁}_{, . . . , P}_{ₖ}_{, P}_{₁}_{, . . . , P}_{_{d}} is a homomorphism (of additive abelian groups) from the vector space V to the group E[p] of p-torsion points (a respective portion of “other program data” 120) on the curve.

Suppose the server 102 (or the client 106) wishes to distribute v₁, . . . , vₖεV to a client device 106, the server chooses s₁, . . . , sₖ and r₁, . . . , r_{d} which are secret in Fₚ. Such secrets are shown as respective portions of “other program data” 120. Server 102 then signs the packet vᵢ (i.e., signed blocks 124) by computing

hᵢ=hₛ_{₁}_{R}_{₁}_{, . . . , s}_{ₖ}_{R}_{ₖ}_{, r}_{₁}_{P}_{₁}_{, . . . , r}_{_{d}}_{P}_{_{d}}(vᵢ).

The server publishes R₁, . . . , Rₖ, P₁, . . . , P_{d}, Q, sⱼQ for 1≦j≦k and rᵢQ for 1≦i≦d (i.e., server published data portion of “other program data” 120). Here Q is another point of p-torsion on the elliptic curve distinct from the others such that eₚ(Rⱼ,Q)≠1 and eₚ(Pᵢ,Q)≠1 for 1≦j≦k and 1≦i≦d.

This signature hⱼ (i.e., a homomorphic digital signature 122) is also appended to the data vⱼ and transmitted according to the distribution scheme. Now, at any edge e that computes

$$y ( e ) = {\sum }_{F \text{:} out ( f ) = in ( e )}^{ } {m}_{e} ( f ) y ( f )$$

coding module 116 also computes

$$h ( e ) = {\sum }_{F \text{:} out ( f ) = in ( e )}^{ } {m}_{e} ( f ) h ( f )$$

and transmits h(e) together with the data y(e) as a linear combination of packets. Since the computation of the signature h(e) is a homomorphism, we have that if y(e)=Σᵢαᵢvᵢ then

$$h ( e ) = {\sum }_{i}^{ } {α}_{i} {h}_{i} .$$

### Exemplary Verification Process

Next we describe the verification process implemented by a respective client device 106. Suppose y(e)= [symbol] u₁, . . . , uₖ, v₁, . . . , v_{d} [symbol] , security against corruption for networked storage module 116-2 determines whether

$${\prod }_{1 \leq j \leq k}^{ } e ( {u}_{j} {R}_{j} , {s}_{j} Q ) {\prod }_{1 \leq i \leq d}^{ } e ( {v}_{i} {P}_{i} , {r}_{i} Q ) = e ( h ( e ) , Q ) .$$

This works because if h(e) is the legitimate signature of y(e) then by definition

$$h ( e ) = {\prod }_{1 \leq j \leq k}^{ } {u}_{j} {s}_{j} {R}_{j} + {\prod }_{1 \leq i \leq d}^{ } {v}_{i} {r}_{i} {P}_{i} , \\ thus$$

$$\begin{matrix}e ( h ( e ) , Q ) = e ( {\sum }_{1 \leq j \leq k}^{ } {u}_{j} {s}_{j} {R}_{j} + {\sum }_{1 \leq i \leq d}^{ } {v}_{i} {r}_{i} {P}_{i} , Q ) \\ = {\prod }_{1 \leq j \leq k}^{ } e ( {u}_{j} {s}_{j} {R}_{j} , Q ) {\prod }_{1 \leq i \leq d}^{ } e ( {v}_{i} {r}_{i} {P}_{i} , Q ) ( by bilinearity ) \\ = {\prod }_{1 \leq j \leq k}^{ } e ( {u}_{j} {R}_{j} , {s}_{j} Q ) {\prod }_{1 \leq i \leq d}^{ } e ( {v}_{i} {P}_{i} , {r}_{i} Q ) ( again by bilinearity ) .\end{matrix}$$

The verification uses the bilinearity of the Weil-pairing. Note that all the terms in the above verification can either be computed from the vector y(e) or from the public information.

The signature 122 is a point on the elliptic curve with coordinates in F_{q}, thus the size of the signature is O(log q) bits and this is the transmission overhead. The computation of the signature h(e) requires O(dᵢₙ log p log^{1+ε} q) bit operations where dᵢₙ is the in-degree of in(e). The verification of a signature requires O((d+k)log p log^{1+ε} q) bit operations.

### Proof of Security

Notation of the previous section is also used in this section. To thwart the described signature scheme, an adversary can either produce a hash collision for the function hₛ_{₁}_{R}_{₁}_{, . . . , s}_{ₖ}_{R}_{ₖ}_{, r}_{₁}_{P}_{₁}_{, . . . , r}_{_{d}}_{P}_{_{d}} or he can forge the signature such that the verification goes through. Note that in this situation the adversary has no knowledge of the points s₁R_{, . . . , s}ₖRₖ and r₁P, . . . , r_{d}P_{d}. We first show that even if the adversary knew the points, producing a collision is still as hard as computing discrete logs. We make the claim precise next:

Problem: Hash-Collision. Fix an integer r>1. Input: Given P₁, . . . , Pᵣ, points in a cyclic subgroup of order p (a prime) on an elliptic curve E/F_{q}. Output: Tuples a=(a₁, . . . , aᵣ), b=(b₁, . . . , bᵣ)εFₚ^{r} such that a≠b and

$${\sum }_{1 \leq i \leq r}^{ } {a}_{i} {P}_{i} = {\sum }_{1 \leq j \leq r}^{ } {b}_{j} {P}_{j} .$$

Proposition 1. There is a polynomial time reduction from Discrete Log on the cyclic group of order p on elliptic curves to HASH-COLLISION.

Proof: First we treat the case when r=2. Let P and Q be points of order p on E(F_{q}) that are not the identity. Assume that Q lies in the subgroup generated by P. Our aim is to find a such that Q=aP, to this end we apply the alleged algorithm that solves Hash-Collision to the points P and Q. The algorithm produces two distinct pairs (x,y),(u,v)εFₚ² such that

xP+yQ=uP+vQ.

This gives us a relation (x−u)P+(y−v)Q=O. We claim that x≠u and y≠v. Suppose that x=u, then we would have (y−v)Q=O, but Q is a point of order p (a prime) thus y−u≡0 mod p in other words y=v in Fₚ. This contradicts the assumption that (x,y) and (u,v) are distinct pairs in Fₚ². Thus we have that Q=−(x−u)(y−v)⁻¹P, where the inverse is taken modulo p.

If we have r>2 then we can do one of two things. Either we can take P₁=P and P₂=Q as before and set Pᵢ=O for i>2 (in this case the proof reduces to the case when r=2), or we can take P₁=r₁P and Pᵢ=rᵢQ where rᵢ are chosen at random from Fₚ. We get one equation in one unknown (the discrete log of Q). It is quite possible that the equation we get does not involve the unknown. However, this happens with very small probability as we argue next. Suppose the algorithm for HASH-COLLISION gave us that

$${ar}_{1} P + {\sum }_{2 \leq i \leq r}^{ } {b}_{i} {r}_{i} Q = O$$

then as long as Σ_{2≦i≦r}bᵢrᵢ≢0 mod p, we can solve for the discrete log of Q. But the rᵢ's are unknown to the oracle for Hash-Collision and so we can interchange the order in which this process occurs. In other words, given bᵢ, for 2≦i≦r, what is the probability that the rᵢ's we chose satisfy Σ_{2≦i≦r}bᵢrᵢ=0? It is clear that the latter probability is 1/p. Thus with high probability we can solve for the discrete log of Q.

One can also conclude the above proposition from the proof presented in Bellare, M.; Goldreich, O.; Goldwasser, S.; Incremental cryptography: The case of hashing and signing, in Advances in Cryptology CRYPTO'94, Santa Barbara, Calif., 1994. This proof deals with finite fields but the argument applies equally well to the case of elliptic curves.

We have shown that producing hash collisions in the scheme implemented by digital signature for network coding module 116 is difficult. The other method by which an adversary can foil the scheme is by forging a signature. However, forging a signature is at least as hard as solving the so-called computational co-Diffie-Hellman problem on the elliptic curve. The only known way to solve this problem on elliptic curves is via computing discrete-logs. Thus forging a signature is at least as hard as solving the computational co-Diffie-Hellman on elliptic curves and probably as hard as computing discrete-logs.

### Exemplary Setup

The notation presented above when describing the network coding model and exemplary homomorphic signature scheme is also utilized in this section. To initialize the signature scheme module 116 of FIG. 1 selects a prime p along with an as described below over a suitable field that has the whole p-torsion defined over that field. Exemplary techniques to select an elliptic curve are described below in the section titled “Finding a Suitable Elliptic Curve”. Module 116 also identifies a set of p-torsion points which are needed to define the homomorphic signature 122. In this section we discuss all these matters and we also provide an example.

In summary:
Pick a large prime p.
Pick a suitable prime (as described below in the section titled “Finding a Suitable Elliptic Curve”) l and an elliptic curve E over Fₗ that has a multiple of p many points.

Find an extension F_{q} of the field Fₗ such that E[p]⊂E(F_{q}) (here E[p] refers to the set of all p-torsion points).
Since #E(F)≡0 mod p it has p-torsion points. Let O≠PεE(Fₗ) be a p-torsion point on the curve. Take Rᵢ=aᵢP for 1≦i≦k and Pⱼ=b_{jP} for 1≦j≦d where aᵢ and bᵢ are picked at random from the set 1, . . . , p−1.
Q is a point such that e(Rᵢ,Q)≠1 and e(Pⱼ,Q)≠1. To ensure this, it suffices to pick a point of p-torsion that is defined over F_{q} but not over the smaller field Fₗ. Indeed, let Q be such a point, then if e(Rᵢ,Q)=1 this would imply that e(A,B)=1 for any A,BεE[p] (since Rᵢ and Q generate E[p]) which contradicts the non-degeneracy of the Weil-pairing.
Lastly, module 116 selects the secret keys s₁, . . . , sₖ and r₁, . . . , r_{d} at random from F*ₚ.

### Finding a Suitable Elliptic Curve

In general, if we have an elliptic curve E over a finite field K then the p-torsion points could be defined over an extension of degree Θ(p²) over the field K. The p-torsion points are defined over a small field so that the operations of module 116 can be carried out in polynomial time. In this section we discuss how one can pick a suitable field Fₗ and an elliptic curve over this field that has all its p-torsion defined over a small relative extension of the base field.

The known theory of complex multiplication of elliptic curves can be used to generate elliptic curves over a finite field with a certain number of points on them. The details of this algorithm are not necessary for our usage but, its running time is utilized, so we describe it next. Suppose we wish to produce an elliptic curve E/Fₗ (where l is a prime) that has exactly N points, where N lies in the interval l+1−2\sqrt{l}≦N≦l+1+2\sqrt{l}. Write N as l+1−t and set Dy²=t²−4l, where D or D/4 is squarefree (note that D is negative because of the Hasse bound). Then the algorithm to produce such a curve runs in time |D|^{O(1)}.

In system 100, an elliptic curve is sought with a small multiple of p points, this tells us that the field Fₗ over which we should look for such a curve must have l+1−2\sqrt{l}≦mp≦l+1+2\sqrt{l}. Additionally, t²−4l should have a small squarefree part, since this determines the running time of the method to generate such a curve. A prime l is selected such that 4l=4p²−Dy² for a small (negative) D and also l≡−1 mod p; and we set t=2p. Thus l+1−t=l+1−2p≡0 mod p and so the number of points on the elliptic curve will be a multiple of p and the time to produce such a curve will also be reasonable since |D| is small.

To produce such a prime l, a (negative) D (with |D| small) is selected. It is determined whether ¼(p²−Dy²) is prime for y=0, 1, . . . . Since we are only interested in primes that are ≡−1 mod p, the above check is performed only for those values of y such that −Dy²≡−4 mod p. A conjecture of Lang-Trotter tells us that there will be many values of y that yield a prime. This is also related to a conjecture of Hardy-Littlewood on the prime values of quadratic polynomials. Now the complex multiplication method produces for us an elliptic curve E over Fₗ that has some p-torsion points. However, we need an elliptic curve such that E[p] is defined over a small degree extension of Fₗ. This is where the additional constraint that l≡−1 mod p is used. Since l≡−1 mod p the order of l in F*ₚ is 2. Now a theorem of Koblitz-Balasubramanian shows that in this case the entire p-torsion is defined over a degree 2 extension over the base field, in other words E[p]⊂Fₗ_{²}. Now we have an elliptic curve E/Fₗ (a respective portion of “other program date” 120) and we know that it has all its p-torsion defined over E[l], but how do we find these points? This is the subject of the next paragraph.

Remark 1. The theory of complex multiplication tells us that the curve E depends only on the quantity D. More precisely, for each D there is a finite list of elliptic curves E₁, . . . , Eₘ over a number field K such that E mod l satisfies our requirements. This is illustrated below in the section titled “Example”.

### Finding p-Torsion Points

Let E/Fₗ be the elliptic curve identified using the method given above. Then #E(Fₗ)=l+1−2p, and let m be the largest divisor of #E(Fₗ) that is relatively prime to p. Let P be a random point on the curve E(Fₗ). Suppose mP≠O, then mP is a point of p-power torsion (by Lagrange's theorem). Let i≧1 be the smallest integer such that mpⁱP=O but mp^{u-1}P≠O. Then mpⁱ⁻¹P is a point of p-torsion. Of course, if we found that mP=O we repeat by finding another random point P. The probability that for a random point P, mP=O is at most 1/p and so we will find a non-trivial point of p-torsion with very high probability.

This gives us the piece of the p-torsion defined over Fₗ. To find the piece of the p-torsion defined over Fₗ_{²} we repeat the above process over Fₗ_{²}. To carry this process out we need to know the number of points on E(Fₗ_{²}). It turns out that if E is defined over a finite field K, then the number of points on E over any extension of K is determined by #E(K). The theory predicts that for our curve E, #E(Fₗ_{²})=l²+1−α²− α̅², where α, α̅ are the two roots (in C) of the equation

φ²−2pφ+l=0.

### AN EXAMPLE

This example was produced using the computer algebra package MAGMA. For this example we take D=−4. For any prime p, a suitable prime l is one that satisfies 4l=4p²+4y² such that l≡−1 mod p. The congruence implies that y²=−1 mod p, in other words −1 should be a quadratic residue mod p. This in turn implies that p=1 mod 4, and that values of y that we need to search should be congruent to one of the square roots of −1 mod p.

Let p be a prime as follows:

26330018368571742206574632566065508402231508999153.

We search for prime values of p²+y² with special properties. The complex multiplication method tells us that the elliptic curve

E:y²=x³+x(in affine form)

is a suitable elliptic curve. MAGMA tells us that #E(F) is:

3516881927290816899634862215683448167044556755196219863066511191456976613264142 847616337439963943072004,

which is indeed ≡0 mod p. The number of points on E(Fₗ_{²}) according to MAGMA is

1236845849050477072586861412005782314655826646818745936122594860084650180144846 0142653837393007842909634176991355780216434931187550854726269234703885776384142 268869493894468081319453336772812036965744626464,

and this is ≡0 mod p², which is a necessary condition for E[p] being a subgroup of E(Fₗ_{²}). We show that E[p] is indeed contained in E(Fₗ_{²}) by finding two points that generate the p-torsion subgroup. Following the method outlined in §5.2 we find two points of p-torsion P and Q that generate the whole p-torsion of E(Fₗ_{²})

P=(276701049983509532234106338452082440292711762773463732533683876759414814860205 8330843763239769722154862,736895619074862870441993260428363309212341952700619 999020137331297834986221601940750818713297548511336)

Q=(170343693342782875614389009934880452275069084044323551866473740367532495756430 3078396992524604785250333u+15712887469866185499501681171672209515250776009 77567312986377817436996986291386148589353156799909434396, 293262979414624776596432402939618431893907517428095829765520553326321029472 565240814005665686795414190u+28272291365284541630011849371574061637952 191623737718932812446648142173368705416653836715431228856385081).

Here u is a variable that gives the isomorphism Fₗ_{²}≅Fₗ[u]/(f(u)) for a quadratic irreducible fεFₗ[u]. The Weil pairing of P and Q is

eₚ(P,Q)=18803618029983537254653390382035462993205409477769908010460 37660415779359581593172656075406185808275672u+31284655683961117025378938265048897550540714 78912095275807108199402549356171889616725860797979581965315.

### An Exemplary Procedure

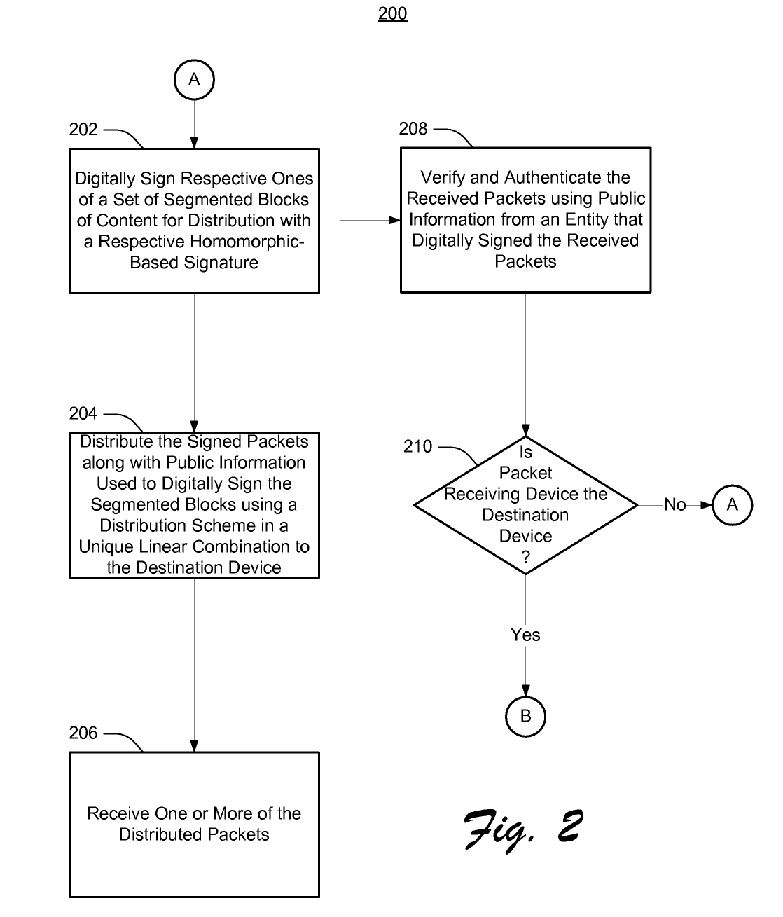

FIG. 2 shows an exemplary procedure 200 for security against corruption for networked storage, according to one embodiment. For purposes of exemplary description, the operations of procedure 200 are described with respect to components of system 100 of FIG. 1. The leftmost numeral of a component reference number indicates the particular figure where the component is first described.

The block 202, a server 102 digitally signs respective ones of a set of segmented blocks of content for distribution with respective homomorphic digital signatures 122 (FIG. 1). This is accomplished by transforming vectors (e.g., respective ones of the segmented blocks) into a set of points on an elliptic curve. These transformations are performed using a collision resistant hash function that is a homomorphism (of additive abelian groups) from a vector space to a group of a prime number of torsion points on an elliptic curve.

At block 204, server 102 distributes the packets along with public information (e.g., certain distinct prime number (p) torsion points on the elliptic curve) used to sign the segmented content encapsulated in the packets, across network 104 to a destination device (e.g., a respective client device 106). The packets and information are distributed using a distribution scheme. In one implementation, the distribution scheme is a network coding distribution scheme. Secret information such as secret keys and hash digests, which were used in the operations of block 202 to digitally sign the segmented content (i.e. vectors), are not distributed by server 102 with the linear combination of packets and the public information.

At block 206, a client device 106 receives one or more of the distributed linear combination of packets. At block 208, the client device 106 verifies and authenticates content encapsulated in the received packets using the public information distributed by the server along with the received packets. At block 210, the client device 106 determines whether it is the final destination device for receipt of the received packets. If not, operations continue at block 202 as described above (and as illustrated by on-page reference “A”), wherein the client device 106, in effect, becomes the server 102. More particularly, in this scenario, the client device 106, knowing the digital signatures of some of the linear combination of packets, the client device 106 can produce a signature of any linear combination of the packets (i.e., the received packets). This allows the client device 106 to digitally re-sign the packets without contacting the source (i.e. in this iteration, server 102). Additionally, this allows the client device to detect any node (e.g., a server 102 and/or a client 106) that maliciously claimed that linear combination of inputs was sent, when in fact the node injected some other data or garbage. With this in mind, the client device distributes the re-signed packets in a new linear combination, along with associated public information used to digitally sign the segmented blocks, to the destination device. The operations of blocks 202 through 210 are interactively repeated by any number of servers 102 and client devices 106 until the distributed content has reached the destination device.

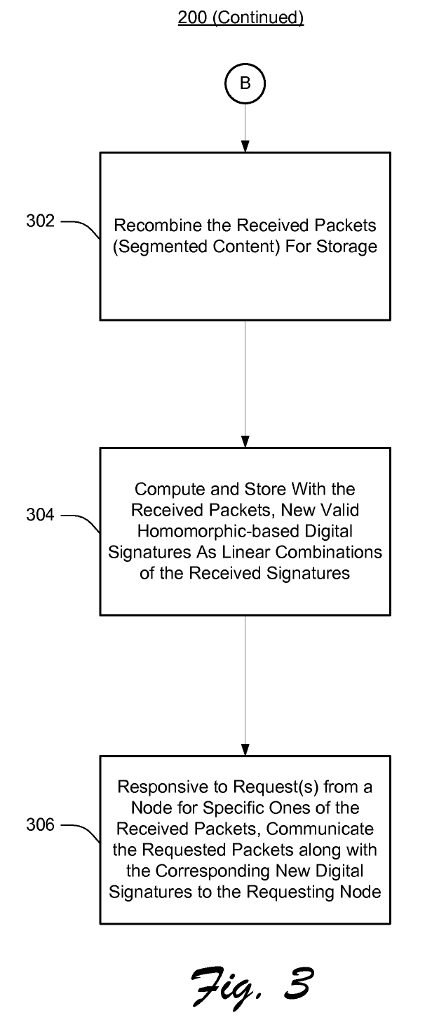

At block 210, if client device 106 determines it is the final destination device for receipt of the received packets, operations of procedure 200 continue at block 302 of FIG. 3 as illustrated by on-page reference “B”.

FIG. 3 shows further aspects of the exemplary procedure 200 FIG. 2 for security against corruption for networked storage, according to one embodiment. At block 302, the packet receiving node 106 recombines the received packets for storage. At block 304, coding model 116-2 computes new homomorphic digital signatures 122-2 based on linear combinations of signatures 122-1 indicated by respective ones of the received packets Signatures are elements of the group of p-torsion points on the elliptic curve, and the signature scheme has been designed to be homomorphic, so that signatures on packets can be added as elements of the group (points on the elliptic curve) to form new valid signatures on corresponding combined packets. The recombined packets along with the newly generated digital signatures 122-2 are shown in FIG. 1 as signed blocks 124-2.

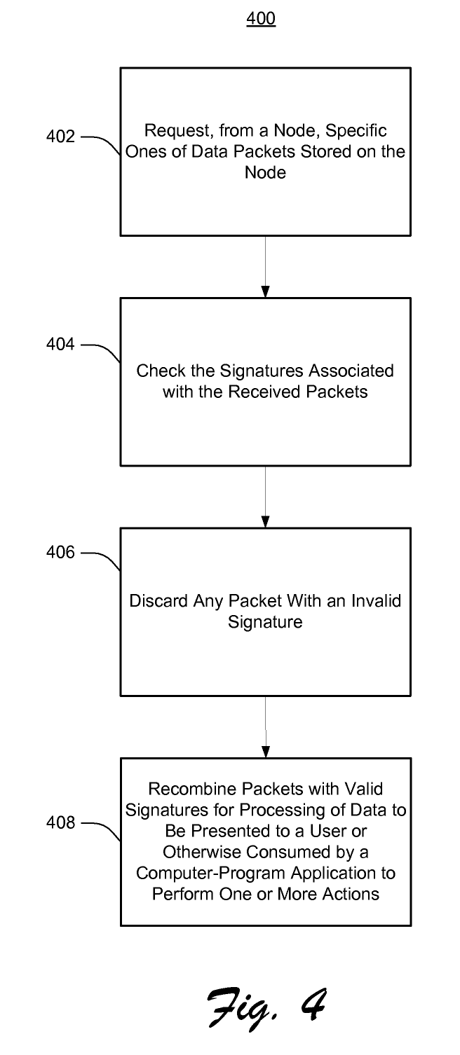

Operations of block 306, responsive to receiving request(s) from a node 106 for specific ones of the received packets (i.e., corresponding data), communicates the requested data along with the corresponding new digital signature(s) (i.e. signed block(s) 124-2) To the requesting node 106. The requesting node 106 verifies and authenticates whether the received data has been corrupted or otherwise polluted since it was sent by the original user (e.g., please see block 204 of FIG. 2) via the operations of FIG. 4.

FIG. 4 shows an exemplary procedure 400 for a node to determine whether requested data received from one or more other nodes in a network has been corrupted or otherwise polluted since it was distributed from an original user to see other node(s), according to one embodiment. Operations of block 402 request, by a node 106, data corresponding to specific ones of data packets stored on one or more other nodes 106 in network 104. Operations of block 404, responsive to receiving the requested data, check digital signatures associated with the received data to verify whether the received data has been corrupted or otherwise polluted since it was stored on network 104. Signatures are verified by computing Weil pairings as described in paragraph [0028].

Operations of block 406 discard, by the receiving node, any received data packet with an invalid signature. Operations of block 408 recombined packets with valid signatures for processing of data to be presented by user or otherwise consumed by a computer program application to perform one or actions. For instance, the recombined packets could represent; a video stream that is displayed to the user by means of media player software such as Windows Media Player; or an installer package that can be executed to install or update software on the user's machine; or backed information that is transmitted to the user machine to perform a restore operation following the loss of some previously backed up user data, etc. There are many other such examples. The particular operations for processing the data or for consuming the data to perform one or more actions are completely arbitrary being a function of the particular computer-program module requesting the data. There are many known practical and tangible uses for data retrieved from network nodes.

### CONCLUSION

Although the above sections describe security against corruption for networked storage in language specific to structural features and/or methodological operations or actions, the implementations defined in the appended claims are not necessarily limited to the specific features or actions described. Rather, the specific features and operations for security against corruption for networked storage described above are exemplary forms of implementing the claimed subject matter.

1. A method at least partially implemented by a computing device, the method comprising:
receiving, by a destination device, a linear combination of packets, the linear combination of packets comprising digitally signed blocks of content and public information used to digitally sign segmented blocks;
recombining, by the destination device, the linear combination of packets to compute new valid signatures as linear combinations of received homomorphic digital signatures; and
wherein the new valid signatures are for verifying, by one or more receiving nodes responsive to a request from the destination device for at least a subset of the linear combination of packets, the integrity of at least that subset.

2. The method of claim 1, wherein the digitally signed blocks of content represent segmented content that has been converted to vectors in a finite dimensional vector space over a large primary field of cryptographic size.

3. The method of claim 1, wherein the digitally signed blocks of content represent segmented blocks of content that have been digitally signed with respective homomorphic digital signatures to create digitally signed blocks of content, the homomorphic digital signatures and the public information allowing a device receiving one or more packets of the linear combination of packets to verify and authenticate content associated with the one or more packets independent of secure transmission of secret keys and hash digests used to digitally sign the one or more packets.

4. The method of claim 1, wherein the destination device receives the linear combination of packets via a network coding content distribution scheme.

5. The method of claim 1, wherein the public information comprises distinct prime numbers and points on an elliptic curve used to sign the segmented blocks.

6. The method of claim 1, wherein homomorphic digital signatures associated with the digitally signed blocks of content and the public information allow a device receiving one or more packets of the linear combination of packets to re-sign content associated with any subset of the linear combination of packets independent of contacting a source of the one or more packets, the re-signed content for subsequent distribution in a new linear combination to the destination device, and for subsequent verification and authentication and distribution by any intermediate client device that is not the destination device.

7. The method of claim 1, wherein the digitally signed blocks are digitally signed by:
picking a large prime;
selecting a suitable prime l and an elliptic curve E over Fₗ that has a multiple of p many points;
locating an extension F_{q} of the field Fₗ such that E[p]⊂E(F_{q}), E[p] being associated with a set of all p-torsion points;
determining an R_{q}=aᵢP for 1≦i≦k and Pⱼ=bⱼP for 1≦j≦d where aᵢ and bᵢ are picked at random from a set 1, . . . , p−1, since #E(Fₗ_{²})=0 mod p then it has p-torsion points, and O≠PεE(Fₗ) is one such p-torsion point on the elliptic curve;
selecting secret keys s₁, . . . , sₖ and r₁, . . . , r_{d} at random from F*ₚ; and
hashing vectors of the respective ones into a set of points on the elliptic curve.

8. The method of claim 1, wherein the method further comprises:
receiving a request from a computing device for specific ones of the linear combinations of packets;
communicating the specific ones to the computing device along with corresponding ones of the new valid signatures; and
wherein the computing device, responsive to receiving the specific ones, verifies integrity of received packets to discard any packet with an invalid signature that is not a corresponding one of the new valid signatures, the computing device being able to recombine received packets with valid signatures for use.

9. A computer-readable data storage medium comprising computer-program instructions executable by a processor for:
requesting, from a computing device, a linear combination of data packets stored on a different computing device, the linear combination of data packets having been distributed to the different computing device using a network coding content distribution scheme, the linear combination of packets being initially digitally signed with respective homomorphic digital signatures to create digitally signed blocks of content, responsive to receiving the linear combination of data packets, the different node having recombined the linear combination of packets to generate corresponding new valid signatures for respective ones of the linear combination of packets from the homomorphic digital signatures;
responsive to the requesting, receiving the linear combination of data packets from the different computing device;
determining, for each packet of the linear combination of packets, validity of a digital signature associated with the packet using a corresponding one of the new valid signatures; and
responsive to the determining, retaining only received ones of the linear combination of packets that have a corresponding valid digital signature.

10. The computer-readable data storage medium of claim 9, wherein the digitally signed blocks of content represent segmented content that has been converted to vectors in a finite dimensional vector space over a large primary field of cryptographic size.

11. The computer-readable data storage medium of claim 9, wherein the homomorphic digital signatures and associated public information allow a device receiving one or more packets of the linear combination of packets to verify and authenticate content associated with the one or more packets independent of secure transmission of secret keys and hash digests used to digitally sign the one or more packets.

12. The computer-readable data storage medium of claim 11, wherein the associated public information comprises distinct prime numbers and points on an elliptic curve used to sign the segmented blocks.

13. The computer-readable data storage medium of claim 9, wherein homomorphic digital signatures and associated public information allow a device receiving one or more packets of the linear combination of packets to re-sign content associated with any subset of the linear combination of packets independent of contacting a source of the one or more packets, the re-signed content for subsequent distribution in a new linear combination to the destination device, and for subsequent verification and authentication and distribution by any intermediate client device that is not the destination device.

14. The computer-readable data storage medium of claim 9, wherein the digitally signed blocks of content are digitally signed by:
picking a large prime;
selecting a suitable prime l and an elliptic curve E over Fₗ that has a multiple of p many points;
locating an extension F_{q} of the field Fₗ such that E[p]⊂E(F_{q}), E[p] being associated with a set of all p-torsion points;
determining an Rᵢ=aᵢP for 1≦i≦k and Pⱼ=bⱼP for 1≦j≦d where aᵢ and bᵢ are picked at random from a set 1, . . . , p−1, since #E(Fₗ_{²})=0 mod p then it has p-torsion points, and O≠PεE(Fₗ) is one such p-torsion point on the elliptic curve; selecting secret keys s₁, . . . , sₖ and r₁, . . . , r_{d} at random from F*ₚ; and
hashing vectors of the respective ones into a set of points on the elliptic curve.

15. A distributed computing system comprising:
digitally signing, by a first computing device using respective homomorphic digital signatures, respective ones of a set of segmented blocks of content to create digitally signed blocks of content;
distributing, by the first computing device using a distribution scheme, a linear combination of packets to a destination device, the linear combination of packets comprising the digitally signed blocks of content and public information used to digitally sign the respective ones of the segmented blocks;
receiving, by a second computing device coupled to the first computing device in the distributed computing system, a linear combination of packets, the linear combination of packets comprising digitally signed blocks of content and public information used to digitally sign segmented blocks;
recombining, by the second computing device, the linear combination of packets to compute new valid signatures as linear combinations of received homomorphic digital signatures; and
wherein the homomorphic digital signatures and the public information allow a device receiving one or more packets of the linear combination of packets to verify and authenticate content associated with the one or more packets independent of secure transmission of secret keys and hash digests used to digitally sign the one or more packets.

16. The distributed computing system of claim 15, wherein the distribution scheme is a network coding content distribution scheme.

17. The distributed computing system of claim 15, wherein the public information comprises certain distinct prime numbers and points on an elliptic curve used to sign the respective ones.

18. The distributed computing system of claim 15, wherein the homomorphic digital signatures and the public information allow a device receiving one or more packets of the linear combination of packets to re-sign content associated with any subset of the linear combination of packets independent of contacting a source of the one or more packets, the re-signed content for subsequent distribution in a new linear combination to the destination device, and for subsequent verification and authentication and distribution by any intermediate client device that is not the destination device.

19. The distributed computing system of claim 15, wherein operations for digitally signing the respective ones further comprises instructions for transforming vectors of the respective ones into a set of points on an elliptic curve using a collision resistant hash function that is a homomorphism from a vector space to a group of a prime number of torsion points on the elliptic curve.

20. The distributed computing system of claim 15, further comprising:
receiving, by the second computing device a request from a computing device for specific ones of the linear combinations of packets;
communicating the specific ones to the computing device along with corresponding ones of the new valid signatures; and
wherein the computing device, responsive to receiving the specific ones, verifies integrity of received packets to discard any packet with an invalid signature that is not a corresponding one of the new valid signatures, the computing device recombining received packets with valid signatures for use.
